(19) United States
(12) Patent Application Publication
(10) Pub. No.: US 2010/0299877 A1
(43) Pub. Date: Dec. 2, 2010

(54) Hinge Device Having Interconnected C-Shaped Clamps

(76) Inventors: Chao-Ming Chang, Chiayi City (TW); Jhih-Hao Jhang, Chiayi City (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/474,146

(22) Filed: May 28, 2009

(51) Int. Cl. E05D 7/00

(52) U.S. Cl. 16/365

(57) ABSTRACT

A hinge device includes: a coupler including a connection part connected to at least three outer clamp members which respectively have open mouths; and at least three inner clamp members fitted rotatably and respectively in the outer clamp members. Each of the inner clamp members has an outer surface surrounding an axis, and two clamping arms defining an axially extending clamping groove therebetween. The clamping groove has a groove opening alignable with the open mouth of one of the outer clamp members. A hoop assembly having at least three hoops interconnected hingedly by the hinge device is also disclosed.

### BACKGROUND OF THE INVENTION

1. Field of the Invention

This invention relates to a hinge device, more particularly to a hinge device having at least three substantially C-shaped clamp members which are interconnected to each other.

2. Description of the Related Art

Referring to FIGS. 1 and 2, there is shown a hoop assembly usable as a game apparatus for children and having hinge devices 11 each of which interconnects two hoops 12. In general, the hoops 12 are of circular cross-section and each of the hinge devices 11 includes two substantially C-shaped clamp members 110 to clamp rotatably and respectively two hoops 12 so that the hoops 12 are hingedly interconnected and are pivotable relative to each other to change an angle formed therebetween. In use, a plurality of hoops 12 are assembled in series using a number of hinge devices 11, and the hoops 12 are set upright to provide a multiplicity of passages for children to pass therethrough.

However, inconveniences are encountered during use of the hoop assembly because the hoops 12 are easily separable from the hinge devices 11 when hit by children, and have to be reassembled frequently during use. In addition, since the hoops 12 are circular in cross-section, a substantial height is built up when multiple hoops 12 are stacked, thereby requiring a large space for storage and transport. If hoops having a flat cross-section are provided in order to save space, the flat cross-section hoops after being clamped will be unable to turn easily and change an angle therebetween.

Applicant's copending U.S. application Ser. No. 12/357,795 discloses a hinge device that can rotatably and firmly interconnect two hoops having flat cross-sections and that permits adjustment of a relative angle between the hoops.

### SUMMARY OF THE INVENTION

An object of the invention is to provide an improved hinge device that can rotatably and firmly interconnect at least three hoops and that permits adjustment of relative angles among the at least three hoops.

Another object of the invention is to provide a hoop assembly that comprises the aforesaid hinge device.

According to one aspect of the present invention, a hinge device comprises: a coupler including a connection part, and at least three substantially C-shaped outer clamp members which are all connected to the connection part and which respectively have open mouths, the open mouths being disposed oppositely of the connection part and at angularly spaced apart positions around the connection part; and at least three substantially cylindrical inner clamp members fitted rotatably and respectively in the outer clamp members. Each of the inner clamp members has a substantially cylindrical outer surface surrounding an axis, and two clamping arms defining an axially extending clamping groove therebetween. The clamping groove has a groove opening alignable with the open mouth of one of the outer clamp members.

According to another aspect of the present invention, a hoop assembly comprises at least three hoops interconnected hingedly by the hinge device. Each of the hoops has a noncircular cross-section that is substantially flat. Each of the hoops further has an annular inner rim, an annular outer rim surrounding the inner rim, and an annular intermediate section connected between the inner and outer rims. The inner and outer rims are thicker than the intermediate section. The inner clamp members of the hinge device respectively clamp the hoops by receiving the hoops in the clamping grooves.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional hoop assembly;

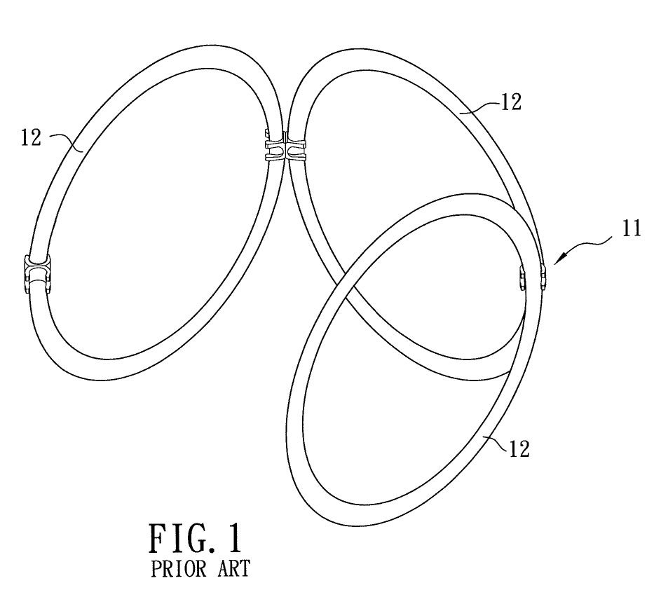

FIG. 2 is a partly sectional view of the conventional hoop assembly;

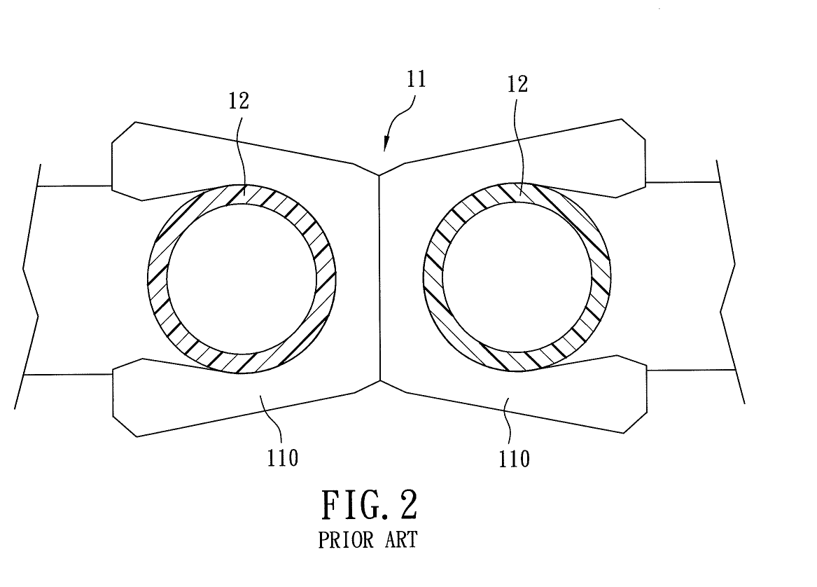

FIG. 3 is a perspective view of a hoop assembly according to the first preferred embodiment of this invention;

FIG. 4 is a fragmentary partly exploded view of the first preferred embodiment;

FIG. 5 is a fragmentary assembled sectional view of the first preferred embodiment;

FIG. 6 is the same view as FIG. 5, but illustrating that inner clamp members are rotated within respective outer clamp members;

FIG. 7 is a perspective view of a hoop assembly according to the second preferred embodiment of this invention;

FIG. 8 is a fragmentary partly exploded view of the second preferred embodiment; and

FIG. 9 is a fragmentary partly exploded view of the third preferred embodiment of this invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

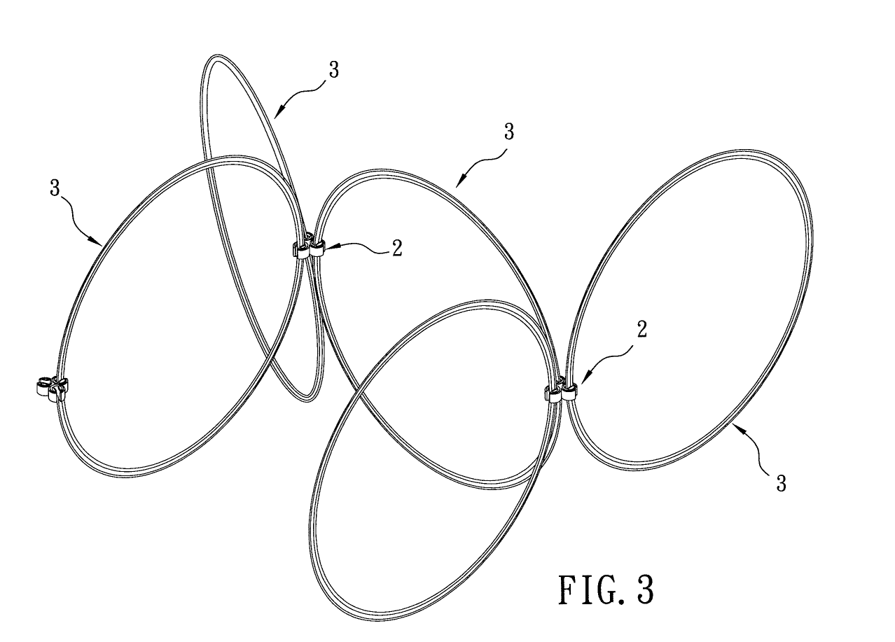

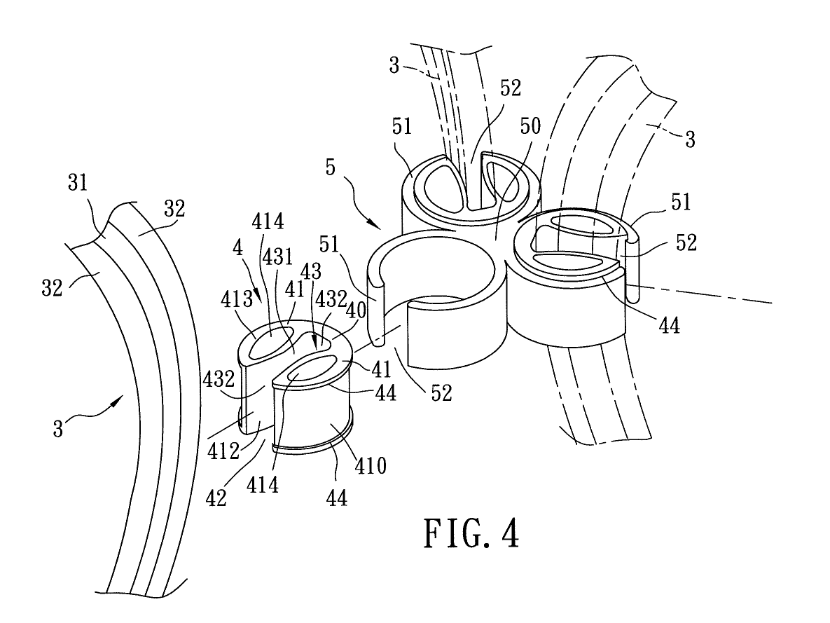

FIGS. 3 to 5 illustrate a hoop assembly according to the first preferred embodiment of this invention.

The hoop assembly includes a plurality of hoops 3 and hinge devices 2. Each of the hoops 3 is substantially flat and has annular inner and outer rims 32 and an annular intermediate section 31 connected between the inner and outer rims 32. The inner and outer rims 32 are thicker than the intermediate section 31. In this embodiment, each of the hinge devices 2 includes a coupler 5 and three substantially cylindrical inner clamp members 4.

The coupler 5 has a connection part 50 and three substantially C-shaped outer clamp members 51 which are all connected to the connection part 50 and which respectively have open mouths 52. The open mouths 52 of the outer clamp members 51 are disposed oppositely of the connection part 50 and are spaced apart from each other by an angle of substantially 120 degrees. In this embodiment, the outer clamp members 51 are formed integrally as one piece with the connection part 50, and the connection part 50 has a triangular prism-like shape.

The inner clamp members 4 are fitted rotatably and respectively in the outer clamp members 51. Each of the inner clamp members 4 has a substantially cylindrical outer surface 410 surrounding an axis, two clamping arms 41 defining an axially extending clamping groove 43 therebetween, and a connection web 40 connected between the clamping arms 41. The cylindrical outer surface 410 of the inner clamp member 4 extends circumferentially around the clamping arms 41 and the connection web 40.

The clamping groove 43 has two diametrically opposite groove end sections 432, a middle groove section 431 between the groove end sections 432, and a groove opening 42 adjacent to one of the groove end sections 432 and opposite to the connection web 40. The groove opening 42 is alignable with the open mouth 52 of the corresponding outer clamp member 51. The clamping groove 43 has a width that decreases gradually from the groove end sections 432 to the middle groove section 431. Each of the inner clamp members 4 further has two axially opposite flanges 44 protruding circumferentially and outwardly from the cylindrical outer surface 410 thereof for retaining therebetween the corresponding outer clamp member 51 which surrounds the cylindrical outer surface 410 thereof.

Each of the clamping arms 41 has an outer wall 413 extending from the connection web 40 to the groove opening 42 along the outer surface 410, a compressible inner wall 412 bounding the clamping groove 43, and a hollow space 414 between the inner and outer walls 412, 413. The inner wall 412 is convexed toward the clamping groove 43 and has two ends one of which is connected to the outer wall 413 adjacent to the connection web 40 and the other one of which is connected to the outer wall 413 adjacent to the groove opening 42. Due to the presence of the hollow space 414, the inner wall 412 is compressible.

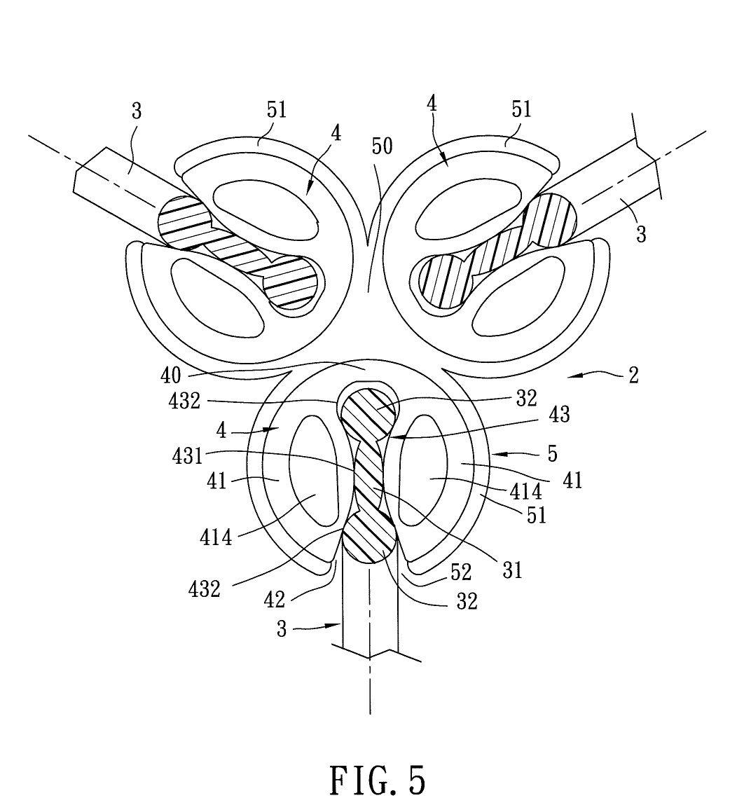

In assembly, three hoops 3 are coupled together by one hinge device 2. The hoops 3 are inserted into the clamping grooves 43 of the respective inner clamp members 4 through the respective groove openings 42 and are clamped by the clamping arms 41 of the respective inner clamp members 4, as shown in FIG. 5.

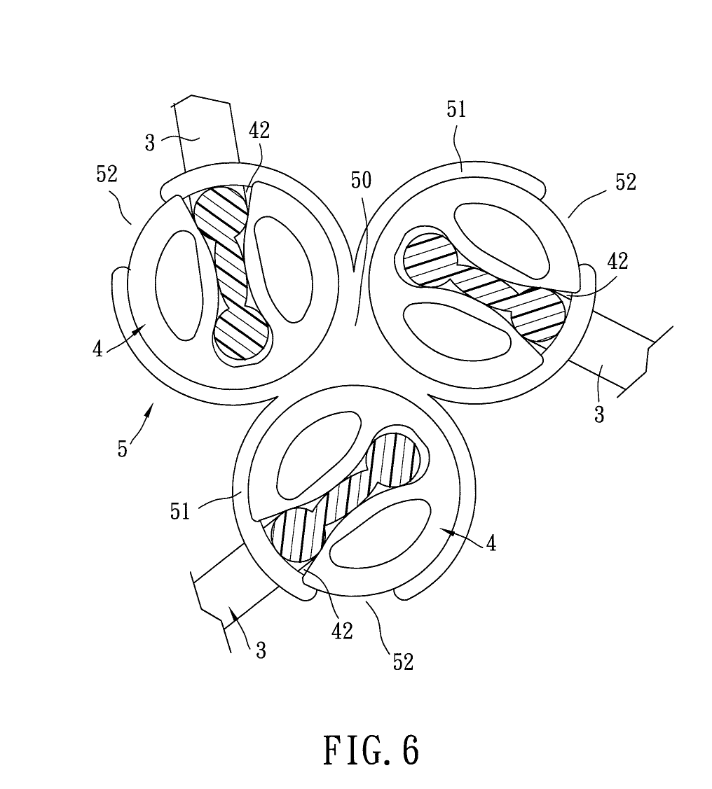

The inner clamp members 4 are rotatable within the respective outer clamp members 5 for adjusting relative angles among the hoops 3. Referring to FIG. 6, each of the inner clamp members 4 is rotated within the corresponding outer clamp member 51 so that the groove opening 42 thereof is moved away from the open mouth 52 of the outer clamp member 51.

As the groove opening 42 is out of alignment with the open mouth 52, the hoop 3 can be effectively prevented from being released from the inner clamp member 4 even when the hoop 3 is subjected to a hitting force. This is one of the advantages of the hinge device 2 of the present invention. Another advantage is that the hinge device 2 can effectively clamp the hoops 3 which are substantially flat in cross-section. When the hoops 3 are stacked, the overall size thereof can be minimized compared to the prior art, thereby reducing the space needed for storage and transport of the hoops 3.

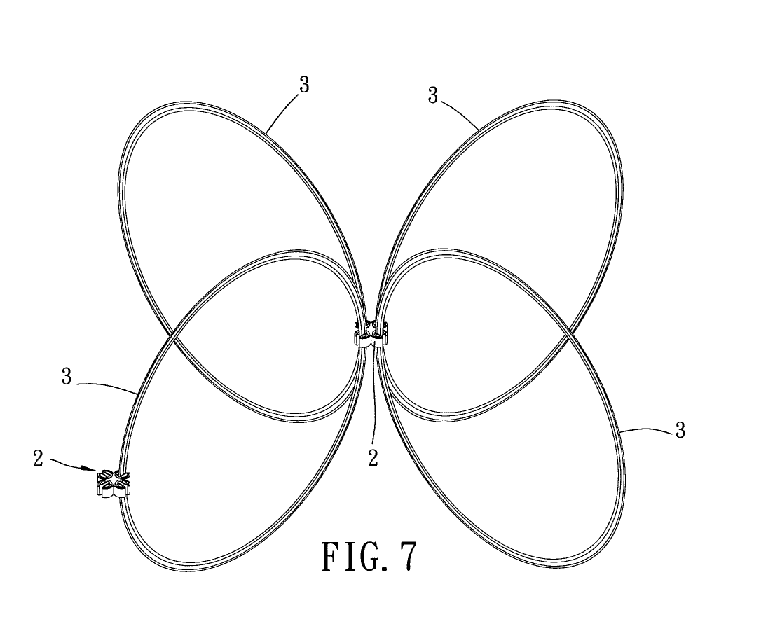

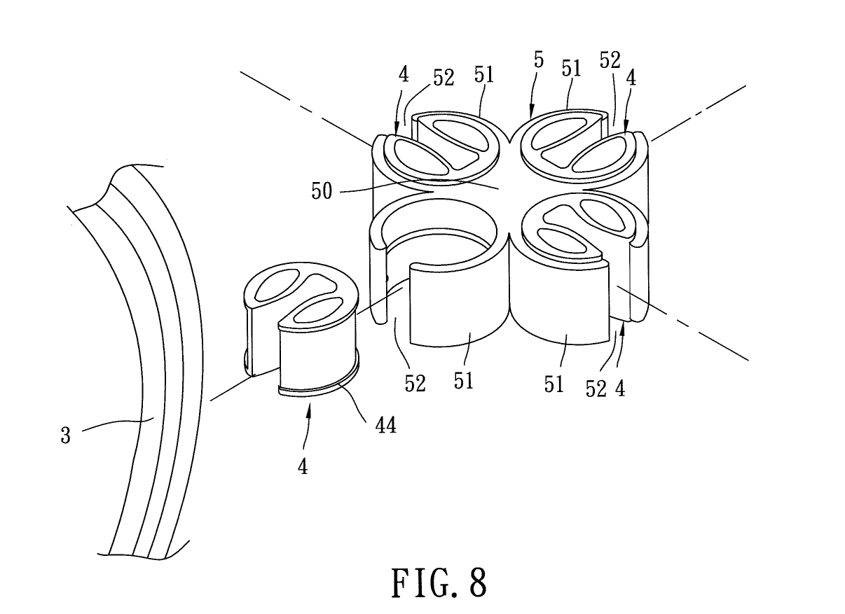

Referring to FIGS. 7 and 8, the second preferred embodiment of the present invention differs from the first embodiment in that the connection part 50 has a cuboid-like shape, and the coupler 5 includes four outer clamp members 51 for clamping four inner clamp members 4. The open mouths 52 are spaced apart from each other by an angle of substantially 90 degrees. In assembly, four hoops 3 are coupled together by one hinge device 2.

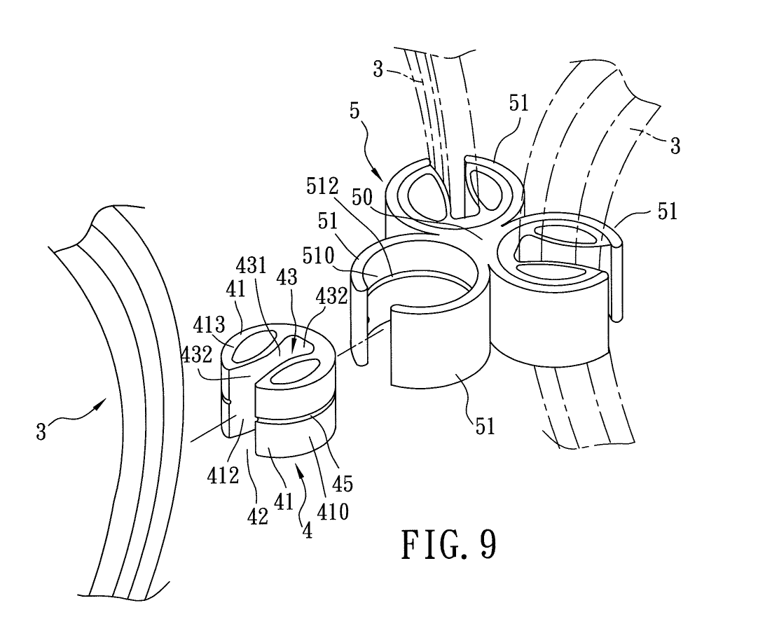

Referring to FIG. 9, the third preferred embodiment differs from the first preferred embodiment in that each of the inner clamp members 4 has an annular recess 45 formed in the outer surface 410, and each of the outer clamp members 51 has an inner surface 510, and an annular rib 512 protruding inwardly from the inner surface 510 and engaging slidably the annular recess 45 of the corresponding inner clamp member 4 for preventing the inner clamp member 4 from being released from the outer clamp member 51.

While the present invention has been described in connection with what are considered the most practical and preferred embodiments, it is understood that this invention is not limited to the disclosed embodiment but is intended to cover various arrangements included within the spirit and scope of the broadest interpretation so as to encompass all such modifications and equivalent arrangements.

What is claimed is:

1. A hinge device comprising:
a coupler including a connection part, and at least three substantially C-shaped outer clamp members which are all connected to said connection part and which respectively have open mouths, said open mouths of said outer clamp members being disposed oppositely of said connection part and at angularly spaced apart positions around said connection part; and
at least three substantially cylindrical inner clamp members fitted rotatably and respectively in said outer clamp members, each of said inner clamp members having a substantially cylindrical outer surface surrounding an axis, and two clamping arms defining an axially extending clamping groove therebetween, said clamping groove having a groove opening alignable with said open mouth of one of said outer clamp members.

2. The hinge device of claim 1, wherein said clamping groove of each of said inner clamp members has two diametrically opposite groove end sections, and a middle groove section between said groove end sections, one of said groove end sections being adjacent to said groove opening, said clamping groove having a width that decreases gradually from said groove end sections to said middle groove section.

3. The hinge device of claim 1, wherein each of said inner clamp members further has a connection web opposite to said groove opening and connected between said clamping arms.

4. The hinge device of claim 3, wherein each of said clamping arms has an outer wall extending from said connection web to said groove opening along said outer surface, a compressible inner wall bounding said clamping groove, and a hollow space between said outer and inner walls, said inner wall having two ends one of which is connected to said outer wall adjacent to said connection web and the other one of which is connected to said outer wall adjacent to said groove opening.

5. The hinge device of claim 4, wherein said inner wall is convexed toward said clamping groove.

6. The hinge device of claim 1, wherein each of said inner clamp members has two axially opposite flanges protruding circumferentially and outwardly from said outer surface, each of said outer clamp members contacting said outer surface and being retained between said flanges.

7. The hinge device of claim 1, wherein each of said inner clamp members has an annular recess formed in said outer surface, each of said outer clamp members has an inner surface, and an annular rib protruding inwardly from said inner surface and engaging slidably said annular recess of the respective one of said inner clamp members.

8. The hinge device of claim 1, wherein said outer clamp members of said coupler are formed integrally as one piece with said connection part.

9. The hinge device of claim 1, wherein said open mouths of said three outer clamp members are spaced apart from each other by an angle of substantially 120 degrees.

10. The hinge device of claim 1, wherein said coupler includes four said outer clamp members, said open mouths being spaced apart from each other by an angle of substantially 90 degrees.

11. A hoop assembly comprising:
a plurality of hoops each having a noncircular cross-section that is substantially flat, each of said hoops further having an annular inner rim, an annular outer rim surrounding said inner rim, and an annular intermediate section connected between said inner and outer rims, said inner and outer rims being thicker than said intermediate section; and
a hinge device which includes a coupler and at least three substantially cylindrical inner clamp members;
said coupler having a connection part, and at least three substantially C-shaped outer clamp members which are all connected to said connection part and which respectively have open mouths, said open mouths of said outer clamp members being disposed oppositely of said connection part and at angularly spaced apart positions around said connection part;
said inner clamp members being fitted rotatably and respectively in said outer clamp members, each of said inner clamp members having a substantially cylindrical outer surface surrounding an axis, and two clamping arms defining an axially extending clamping groove therebetween, said clamping groove having a groove opening alignable with said open mouth of one of said outer clamp members; said inner clamp members respectively clamping said hoops by receiving said hoops in said clamping grooves.
